(19) United States
(12) Patent Application Publication
(10) Pub. No.: US 2017/0072767 A1
(43) Pub. Date: Mar. 16, 2017

(54) FLOOR MAT WITH INTELLIGENT CONTROL SYSTEM TO REMOVE MOISTURE

(71) Applicant: FORD GLOBAL TECHNOLOGIES, LLC, Dearborn, MI (US)

(72) Inventors: Stuart C. Salter, White Lake, MI (US); James J. Surman, Clinton Township, MI (US); Annette Lynn Huebner, White Lake, MI (US); Cornel Lewis Gardner, Romulus, MI (US)

(21) Appl. No.: 14/855,014

(22) Filed: Sep. 15, 2015

(51) Int. Cl. B60H 1/00; B60R 1/00; G05B 15/02

(52) U.S. Cl. CPC B60H 1/00021; G05B 15/02; B60R 1/00; B60H 1/00642

(57) ABSTRACT

A floor mat is provided for a motor vehicle. That floor mat includes a body and a controller carried on the body and configured to dry the floor mat. Further, the floor mat includes a moisture sensor carried on the body and adapted to provide floor mat moisture data to the controller. Finally, an associated method for drying the floor mat is provided.

### TECHNICAL FIELD

This document relates generally to the motor vehicle equipment field and, more specifically, to a floor mat for a motor vehicle that incorporates an intelligent control system to remove floor mat moisture.

### BACKGROUND

It has long been known to utilize floor mats on the floor of a motor vehicle in order to protect the carpet from dirt and debris including, particularly, moisture and water stains. In winter weather conditions in northern climates, these floor mats can become covered with snow and/or become soaked from melted snow and ice. These wet floor mat conditions can persist for days or weeks if only short trips are made with the motor vehicle. This is particularly true when temperatures remain below 20 degrees Fahrenheit.

Unfortunately, this can result in the soiling of pants cuffs, leather soled shoes or other items which might be set upon the floor of the motor vehicle. A moisture-saturated floor mat also suffers from reduced insulation value, and high moisture conditions can be a major contributor to cold feet, making the driver or passenger uncomfortable.

This document relates to a new and improved floor mat for a motor vehicle which relies upon an intelligent control system to detect and measure the moisture level of the floor mat and control a heating element embedded in the floor mat and/or an interface with the vehicle heating system to provide sufficient heating and air flow to evaporate the accumulated moisture and thereby dry the floor mat to a desired condition. Significantly, the controller of the intelligent control system will only provide heating when it is needed for floor mat moisture level reduction. In accordance with an additional feature, the heated mat is also useful to provide auxiliary heat to warm the feet as needed or desired, thereby increasing passenger comfort.

### SUMMARY

In accordance with the purposes and benefits described herein, a floor mat is provided for a motor vehicle. The floor mat comprises a body and a controller, carried on the body, that is configured to dry the floor mat. Further, the floor mat includes a moisture sensor that is carried on the body and adapted to provide floor mat moisture data to the controller.

In one possible embodiment, the floor mat further includes a temperature sensor that is carried on the body and adapted to provide floor mat temperature data to the controller.

In one possible embodiment, the floor mat includes a heating element that is carried on the floor mat and is responsive to the controller to heat and dry the floor mat.

In one possible embodiment, the controller includes a communications component allowing the controller to communicate with a control module of a heating, ventilating and air conditioning (HVAC) system of the motor vehicle. The communications component may be a wireless communications component.

In such an embodiment, the controller may be configured to dry the floor mat by (a) controlled operation of the heating element in the floor mat, (b) controlled operation of the HVAC system via interface with the HVAC control module through the communications component or (c) controlled operation of the heating element and the HVAC system. Further, the controller may be configured to display information respecting moisture level and the drying of the floor mat on a display module of the HVAC system.

In any embodiments, the floor mat may also include a power coupling between the electrical components carried on the floor mat and a power source of the motor vehicle.

In accordance with an additional aspect, a motor vehicle may be provided incorporating the floor mat described herein.

In accordance with still another aspect, a method of drying a floor mat in a motor vehicle is provided. That method may be broadly described as comprising the steps of: (a) monitoring, by means of a moisture sensor, a floor mat moisture level, (b) drying, by means of controller controlled heating, the floor mat when the floor mat moisture level exceeds a threshold value and (c) terminating drying when the floor mat moisture level falls to a predetermined end value. The method may also include the additional step of drying the floor mat by means of a heating element in the floor mat and/or drying the floor mat by means of an HVAC system of the motor vehicle.

Further, the method may include providing communication between the controller of the floor mat and an HVAC control module of the motor vehicle. In addition, the method may include displaying on a display module of the HVAC system floor mat moisture data communicated by the controller to the HVAC control module. Still further, the method may include monitoring, by means of a temperature sensor, a floor mat temperature level.

In the following description, there are shown and described several preferred embodiments of the floor mat and related method for its operation. As it should be realized, the floor mat and method are capable of other, different embodiments and their several details are capable of modification in various, obvious aspects all without departing from the floor mat and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the floor mat and method and together with the description serve to explain certain principles thereof. In the drawing figures:

FIG. 1 is a perspective view of the floor mat from above showing the heating element and control module embedded in the body of the floor mat.

FIG. 2 is a schematic block diagram of the floor mat showing the various components thereof, as well as the motor vehicle, including the components of the motor vehicle with which the controller of the floor mat interfaces.

Reference will now be made in detail to the present preferred embodiments of the floor mat, examples of which are illustrated in the accompanying drawing figures.

### DETAILED DESCRIPTION

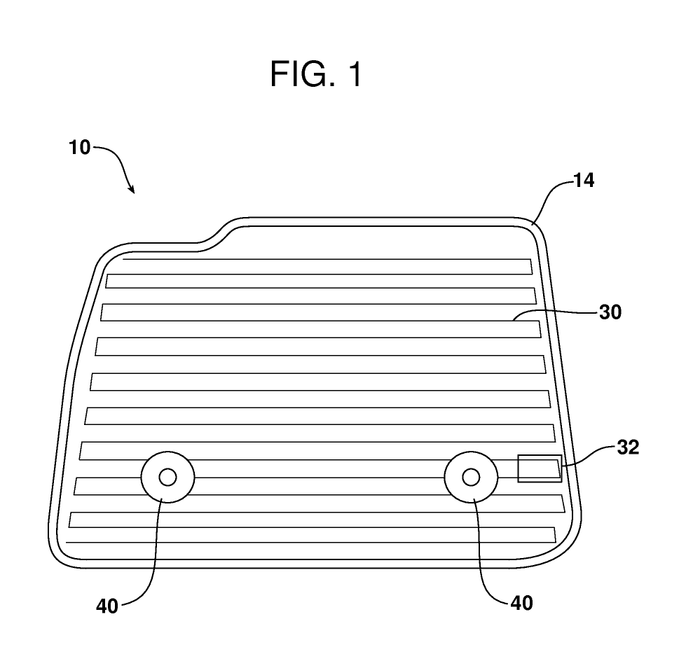

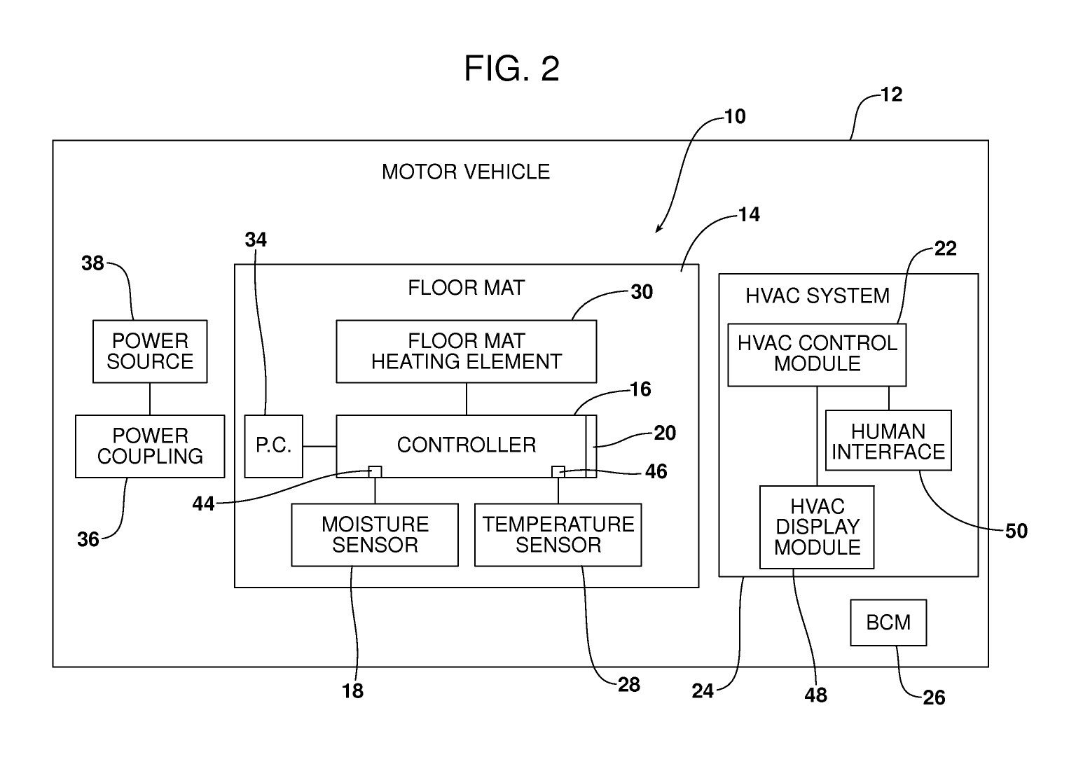

Reference is now made to FIGS. 1 and 2 illustrating the floor mat 10 that is the subject matter of this document as well as a motor vehicle 12 equipped with that floor mat 10. As illustrated in these figures, the floor mat 10 may be broadly described as including a body 14 made from rubber, carpet-encapsulated rubber or other appropriate material. A controller 16 and a moisture sensor 18 are also carried on the body.

More specifically, the controller 16 may comprise a computing device such as a dedicated microprocessor or electronic control unit (ECU) incorporating and running appropriate control software. Thus the controller 16 may include one or more processors, one or more memories and one more network interfaces communicating with each other over a communication bus. As further illustrated and described in greater detail below, the controller also includes a communications component 20. That communications component 20 may be a wireless communication component allowing wireless communication with the HVAC control module 22 of the HVAC system 24 of the motor vehicle 12 or other modules such as a body control module (BCM) 26 in communication with the HVAC control module 22. The BCM 26 performs a number of interior body electrically-based functions including, for example, interior locking, remote key entry, interior light, exterior light, windshield wiper control and the like. In many embodiments, the BCM also functions to control entertainment functions (e.g. radio, CD player and communications such as telephone and Internet communications over a wireless network). The BCM 26, which comprises a computing device including one or more processors, one or more memories and one or more network interfaces, may be connected by a communications bus (not shown) to other control modules such as the HVAC control module 22, that provide one or more additional functions.

As illustrated in FIG. 2, a temperature sensor 28, such as a thermal resistor, may be carried on the body 14 of the floor mat 10. Still further, a floor mat heating element 30 such as the resistive heating element illustrated in FIG. 1 is also carried on the body 14. In one particularly useful embodiment, the controller 20, moisture sensor 18 and temperature sensor 28 are all provided on a single printed circuit board as a control module 32 and both the control module 32 and the floor mat heating element 30 are embedded within the floor mat body 14. Here it should be appreciated that the embedded control module 32 and heating element 30 are protected from water intrusion should one desire to wash the floor mat 10 at any time with, for example, a hose and soapy water.

As also illustrated in FIG. 2, a power coupling 34 is also carried on body 14 of the floor mat 10. The power coupling 34 connects with a cooperating power coupling 36 of the motor vehicle 12. When the power couplings 34, 36 are properly connected together, power from the motor vehicle power source 38 is routed to the electrical components in the floor mat 10 including, for example, the controller 20, moisture sensor 18, temperature sensor 28 and heating element 30. In one possible embodiment, the power couplings 34, 36 have cooperating electrical contacts (not shown) in the fastening elements 40 that secure the floor mat 10 to the vehicle floor 42.

During operation, the moisture sensor 18 monitors the floor mat moisture level and provides data respecting that moisture level to the data input 44 of the controller 16. Similarly, the temperature sensor 28 monitors the temperature of the floor mat 10 and provides temperature data to the data input 46 of the controller 16. More specifically, the controller 16 compares the moisture level data received at the input 44 to predetermined moisture threshold values and is configured to dry the floor mat 10 in response thereto. The drying process is efficiently controlled by the controller 16 based upon temperature data received from the temperature sensor 28 at the input 46.

In the illustrated embodiment, the controller 16 is configured to dry the floor mat 10 by (a) controlled operation of the heating element 30 in the floor mat 10, (b) controlled operation of the HVAC system 24 via interface with the HVAC control module 22 through the communication component 20 or (c) controlled operation of both the heating element 30 and the HVAC system 22. Still further, the controller 16 may also be configured to display information respecting the floor mat moisture level and the estimated time required to dry the floor mat to a predetermined end moisture value on a display module 48 of the HVAC system 24.

In one possible embodiment, the controller 16 is configured to operate in accordance with a control method that measures/monitors floor mat temperature by means of the temperature sensor 28 and floor mat moisture level by means of the moisture sensor 18. The controller 16 then dries the floor mat 10 by controller controlled heating when the floor mat moisture level exceeds a threshold value and subsequently terminates the drying operation when the floor mat moisture level falls to a predetermined acceptable or end value. That drying may be completed by the floor mat heating element 30 operating alone, the HVAC system 24 operating alone and blowing warm air or dry air-conditioned air over the floor mat through the floor vents of the motor vehicle or by operating both the floor mat heating element 30 and the HVAC system 24 simultaneously. Using both the heating element 30 and the HVAC system 24 provides enhanced mat drying.

Throughout the drying process, the controller 16 may provide display information to the HVAC control module 12 through the communications component 20 for display on the HVAC display module 48. Such information may include, for example, the estimated time necessary to dry the mat to a desired moisture level based upon the moisture level of the mat and the means of drying.

As an additional aspect, the controller 16 of the floor mat may be configured to provide additional supplemental heating for the feet of a driver or passenger of the motor vehicle 12 based upon a driver or passenger input through a human interface 50 connected to the HVAC control module 22 which communicates with the controller 16 through the communications module 20.

The foregoing has been presented for purposes of illustration and description. It is not intended to be exhaustive or to limit the embodiments to the precise form disclosed. Obvious modifications and variations are possible in light of the above teachings. For example, the floor mat 10 could also incorporate a vehicle logo or emblem which may be illuminated as desired by means of the power coupling 34,36 via control of the controller 16. Additionally, although the illustrations herein depict a power coupling 34,36 which is electrically conductive and is powered by electrical contact, the power coupling 34,36 may take the form of an inductive coil or other wireless power transfer system if desired. Further, while the illustrated floor mat 10 includes only a single moisture sensor 18 and a single temperature sensor 28, it should be appreciated that it could include multiple sensors of either type provided at spaced positions across the floor mat 10 if desired, and that the controller 16 may integrate multiple signals in order to more efficiently dry the floor mat 10. All such modifications and variations are within the scope of the appended claims when interpreted in accordance with the breadth to which they are fairly, legally and equitably entitled.

What is claimed:

1. A floor mat for a motor vehicle, comprising:
a body;
a controller carried on said body and configured to dry said floor mat; and
a moisture sensor carried on said body and adapted to provide floor mat moisture data to said controller.

2. The floor mat of claim 1, further including a temperature sensor carried on said body and adapted to provide floor mat temperature data to said controller.

3. The floor mat of claim 2, further including a heating element carried on said floor mat and responsive to said controller to heat and dry said floor mat.

4. The floor mat of claim 3, wherein said controller includes a communications component allowing said controller to communicate with a control module of an HVAC system of said motor vehicle.

5. The floor mat of claim 4, wherein said communications component is a wireless communications component.

6. The floor mat of claim 5, wherein said controller is configured to dry said floor mat by (a) controlled operation of said heating element, (b) controlled operation of said HVAC system via interface with said HVAC control module through said communications component or (c) controlled operation of both said heating element and said HVAC system.

7. The floor mat of claim 6, wherein said controller is further configured to display information respecting moisture level and drying of said floor mat on a display module of said HVAC system.

8. The floor mat of claim 7, further including a power coupling between electrical components carried on said floor mat and a power source of said motor vehicle.

9. The floor mat of claim 1, further including a heating element carried on said floor mat and responsive to said controller to heat and dry said floor mat.

10. The floor mat of claim 2, wherein said controller includes a communications component allowing said controller to communicate with a control module of an HVAC system of said motor vehicle.

11. The floor mat of claim 10, wherein said communications component is a wireless communications component.

12. The floor mat of claim 11, wherein said controller is configured to dry said floor mat by controlled operation of said HVAC system via interface with said HVAC control module through said communications component.

13. The floor mat of claim 12, wherein said controller is further configured to display information respecting moisture level and drying of said floor mat on a display module of said HVAC system.

14. A motor vehicle incorporating the floor mat of claim 1.

15. A method of drying a floor mat in a motor vehicle, comprising:
monitoring, by means of a moisture sensor, a floor mat moisture level;
drying, by means of controller controlled heating, said floor mat when said floor mat moisture level exceeds a threshold value; and
terminating said drying when said floor mat moisture level falls to a predetermined end value.

16. The method of claim 15, including drying said floor mat by means of a heating element in said floor mat.

17. The method of claim 15, including drying said floor mat by means of an HVAC system of said motor vehicle.

18. The method of claim 17, including providing communication between a controller on said floor mat and an HVAC control module of said motor vehicle.

19. The method of claim 18, further including displaying on a display module of said HVAC system floor mat moisture data communicated by said controller to said HVAC control module.

20. The method of claim 15, further including providing supplemental heating for feet of an individual through said floor mat based upon an input from said HVAC control module.
